(19) United States
(12) Patent Application Publication
(10) Pub. No.: US 2004/0254794 A1
(43) Pub. Date: Dec. 16, 2004

(54) Interactive eyes-free and hands-free device

(76) Inventor: Carl Padula, Safety Harbor, FL (US)

Correspondence Address: Supervisor, Patent Prosecution Services, PIPER RUDNICK LLP, 1200 Nineteenth Street, N.W., Washington, DC, 20036-2412, US

(21) Appl. No.: 10/840,593

(22) Filed: May 7, 2004

Related U.S. Application Data
(60) Provisional application No. 60/468,913, filed on May 8, 2003.

(51) Int. Cl. G10L 11/00

(52) U.S. Cl. 704/275

(57) ABSTRACT

In a hands-free and eyes-free method and apparatus for testing, questions are presented to a test taker by a recorded or computer-generated simulated voice, and the test taker provides spoken responses which are recognized by a computer using voice recognition techniques. The invention includes trivia game embodiments played for fun as well as examination embodiments for use in practice or actual exams. Preferably, the apparatus is a hand held device. In highly preferred embodiments, questions and answers are stored on user-exchangeable cartridges. Scores may be reported using a computer-generated simulated voice.

This application claims priority from U.S. Provisional Application Ser. No. 60/468,913, entitled “Interactive Hands-Free Device,” filed May 8, 2003. The entirety of that provisional application is incorporated herein by reference.

### BACKGROUND OF THE INVENTION

1. Field of the Invention

The invention relates generally to interactive devices, and more particularly to interactive game, learning and testing devices employing voice recognition.

2. Discussion of the Background

The testing of one's knowledge is a common occurrence in modern life. The testing is sometimes done for fun. For example, playing trivia games such as TRIVIAL PURSUIT™ and others has become a popular pastime, both in the U.S. and abroad. The testing is sometimes done for general education purposes in the classroom as a learning tool or as homework. The testing is sometimes done under more serious circumstances, such as testing in the classroom or testing for, e.g., a driver's license. In addition, it is common for one who is to take a test in the future to take one or more “practice” tests to prepare for the future test.

The testing of a person's knowledge typically involves five separate tasks: 1) the communication of a question to a test taker; (2) the collection of a response to the question from the test taker; (3) the comparison of the response to a correct answer; (4) a calculation of a “score” for the test taker (which may be done for individual questions or may be an aggregate); and (5) the reporting of the score to the test taker(s).

In the distant past, each of these processes were performed manually. More recently, computers have been used to automate one or more of these processes. At first, computers were used to automate steps 3 and 4 of the process. An example of this can be found in the standardized test setting (e.g., the SAT test administered to many high school students in the U.S.), where a test taker is often required to manually fill in a bubble (using, of course, a number 2 pencil) corresponding to a desired answer for each question on a test. The filled-in answer sheet is then scanned by a computer, which automatically compares each filled-in bubble to a correct answer, automatically calculates a score, and automatically prints the score for mailing to the test taker.

It is becoming increasingly popular to use computers to automate the first and second steps. For example, many tests are now administered over the Internet or on local computer networks. In such tests, questions are presented on a computer screen, and a test taker presses a key or uses a mouse to indicate a correct answer. As before, the computer collects these responses, compares them to the correct answers, calculates a score, and displays the score to the user.

However, methods such as those discussed above require the user to pay close attention to a computer screen and to manipulate a computer input/output device such as a mouse or keyboard. Using both hands and eyes to perform these tasks can be tedious. Moreover, there are situations (e.g., riding in a car, plane or train) in which interacting with a computer in this manner is impossible, impractical or inconvenient.

### SUMMARY OF THE INVENTION

The aforementioned issues are addressed to a great extent by the present invention, which provides a hands-free and eyes-free method and apparatus for testing in which questions are presented to a test taker by a recorded or computer-generated simulated voice and in which the test taker provides spoken responses which are recognized by a computer using voice recognition techniques. The invention includes trivia game embodiments played for fun as well as general learning/education purposes and examination embodiments for use in practice or actual exams. Preferably, the apparatus is a hand held device. In highly preferred embodiments, questions and answers are stored on user-exchangeable cartridges. In some embodiments, scores are reported using a computer-generated simulated voice.

### BRIEF DESCRIPTION OF THE DRAWINGS

The aforementioned advantages and features of the present invention will be more readily understood with reference to the following detailed description and the accompanying drawings in which:

FIG. 1 is a block diagram of a trivia game system according to an embodiment of the present invention.

FIGS. 2a and 2b are front and perspective views, respectively, of a housing for the system of FIG. 1 according to an embodiment of the present invention.

FIGS. 3a-3c are flowcharts of the processing performed by the system of FIG. 1 according to an embodiment of the present invention.

### DETAILED DESCRIPTION

In the following detailed description, a plurality of specific details, such as types of prompts, housings, and switches, are set forth in order to provide a thorough understanding of the present invention. The details discussed in connection with the preferred embodiments should not be understood to limit the present invention. Furthermore, for ease of understanding, certain method steps are delineated as separate steps; however, these steps should not be construed as necessarily distinct nor order dependent in their performance.

The invention is believed to have particular utility for the playing of trivia games, general learning, and the taking of practice examinations, and hence will be discussed primarily in that context herein. The invention should not be understood to be so limited.

As used herein, the terms “computer” and “processor” should be understood to include special purpose and general purpose processors, microprocessors, and digital signal processors, and can include a single physical device or multiple devices.

As used herein, the term “spoken” should be understood to mean sounds that correspond to words, whether uttered by a human being, reproduced from a recording, or synthesized by a computer.

As used herein, the terms “question” and “prompt” are used interchangeably to refer to a spoken statement that is intended to elicit a response from a user. Preferably, the question/prompt is in the form of an inquiry such as “Who was the first president of the United States?” In some embodiments, the inquiry is in a multiple choice or true/false format. In highly preferred embodiments, the question/prompt is in a multiple choice format that includes abbreviations (e.g., 1, 2, 3 . . . or a, b, c . . . ) associated with each of the choices. An example of the foregoing question in this format is as follows: “Who was the first president of the United States? a—Thomas Jefferson, b—John Adams c—George Washington, d—Benjamin Franklin.” Both “question” and “prompt” should also be understood to encompass a spoken statement to which a user is required to supply a corresponding “question.” Thus, for example, as used herein, the terms “question” and “prompt” both encompass the statement “Mets and Yankees,” to which a correct response would be “What are the names of major league baseball teams based in New York City?”

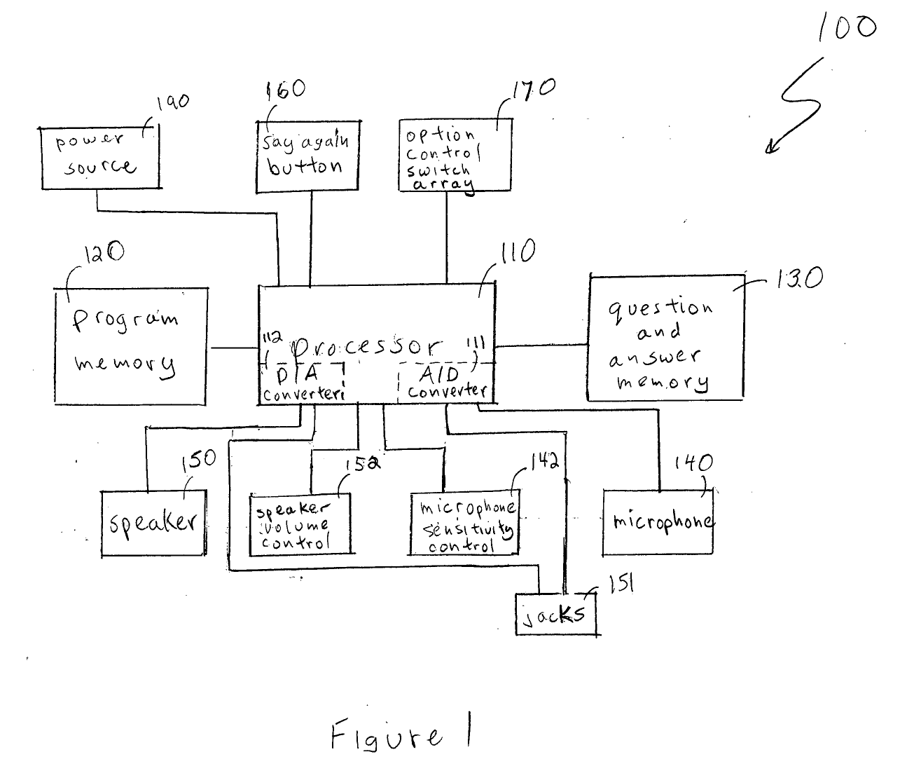

A block diagram of a trivia game system 100 according to an embodiment of the invention is illustrated in FIG. 1. The system 100 includes a processor 110. Attached to the processor 110 is a program memory 120. The program memory 120 stores software instructions that control the processor 110 to perform the functions discussed in further detail below. Also attached to the processor 110 is a question and answer memory 130, which stores the questions and corresponding answers for use during a trivia game. The memory 130 may be permanently attached to the processor 110, or, in preferred embodiments, may be disposed in a removable, user exchangeable cartridge as is common in hand-held video games such as GAMEBOY™. In preferred embodiments, the memory 130 holds digitized recordings of spoken questions to the user.

The system 100 also includes a microphone 140 connected to the processor 110 via A/D converter 111, which is shown as part of processor 110 in FIG. 1 but which may also be a separate device in other embodiments. The microphone 140 is used to sense spoken responses by a user. The digitized spoken responses from the user are converted to a logical form such as text by a voice recognition process performed by the processor 110. The sensitivity of the microphone is controlled by a microphone sensitivity control 142, which preferably includes a pair of momentary contact switches that increment or decrement the amplification applied to the signal output by the microphone 140.

Also connected to processor 110 via D/A converter 112 is a speaker 150. A speaker volume control 152 connected to the processor allows the user to control the volume. In preferred embodiments, the speaker volume control 152 includes two momentary contact switches, one to increase the volume and another to decrease the volume. The processor 110 senses when the either of the switches is depressed and adjusts the output to the speaker 150 accordingly. In some embodiments, the processor 110 will interpret depression of the volume decrease button for a sufficiently long period of time as a command to power down and will transition the system 100 from an “on” state to a low power “ready” state, and will interpret depression of the volume increase switch as an “on” command and will transition the system 100 from the “ready” state to the “on” state. Prompts, which are typically in the form of spoken questions to the user, are output in digital form by the processor 110 to the D/A converter 112, which converts them to analog form for reproduction by the speaker 150.

A “say again” button 160 connected to the processor 110 allows the user to command the processor 110 to repeat a previously asked question. The “say again” button 160 also functions as a “score” button when it is depressed during game play after an answer from any user has been accepted.

The microphone 140 and speaker 150 provide the capability of completely hands-free game play. Questions are output by the speaker 150 in spoken form, and answers in spoken form are sensed by the microphone 140. However, in some situations play in this mode may not be desirable. Thus, preferred embodiments of the invention support play in both a headset mode, which is useful in a high-noise environment such as in a car, and earphone/switch mode, which is useful in a situation such as on an airplane where speaking answers could disturb others. In headset mode, both the speaker output and microphone input are redirected to a jack 151 for connection to a headset with a corresponding earphone speaker 291 and microphone 290. In earphone/switch mode, the speaker output is redirected toward the jacks 151 for connection to the headset earphone speaker 291, the microphones 140 and 290 are deactivated, and the user can indicate a response to multiple choice or true/false questions using the switch array 170. The switch array 170 is preferably a four position switch array with the switches labeled “1” through “4”. The switch array 170 may also be used during game setup to indicate certain game options as will be discussed in further detail below. The switch array 170 may comprise four separate switches or may comprise a 2×2 matrix as is well known in the art.

A power source 190 is connected to processor 110. Preferably, the power source 190 includes batteries as well as a jack (not shown in FIG. 1) that accepts a d/c power input from an a/c adaptor and/or an external battery source (e.g., an accessory plug from a car).

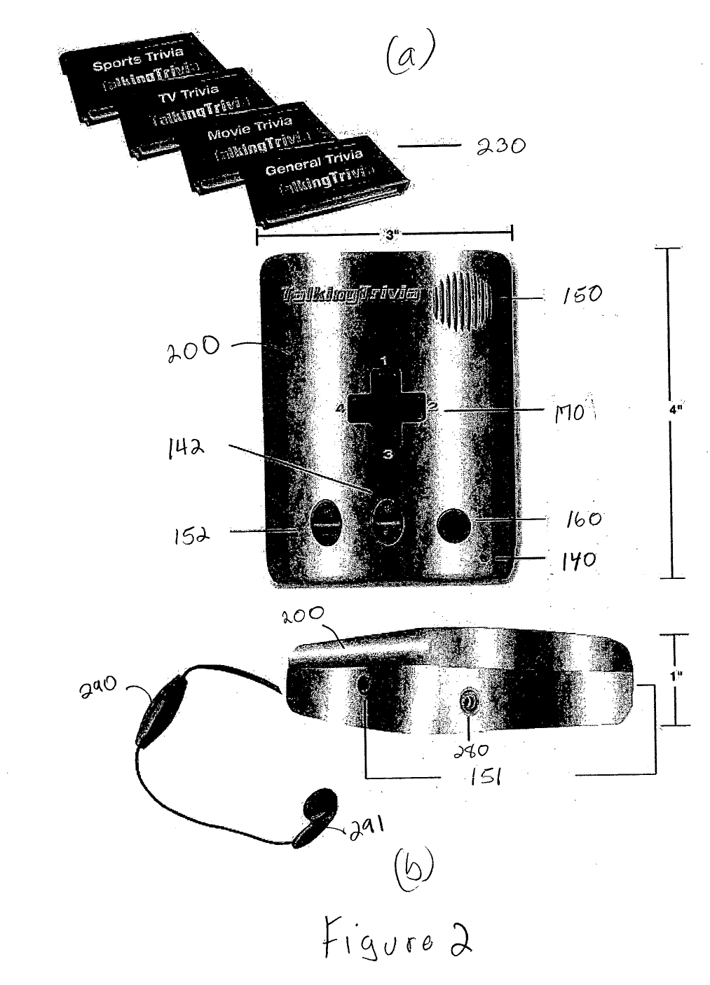

FIGS. 2a and 2b illustrate front and perspective views, respectively of a housing 200 for the system 100 of FIG. 1. Visible on the housing 200 are the microphone 140 and its sensitivity control 142. The speaker 150 and the speaker volume control 152 are also visible in FIG. 2. The housing 200 also includes the combination “say again”/score button 160 and the switch array 170. The bottom of the housing 200 includes an AC adapter jack 280. Headset/earphone jacks 151 are located on both sides of the housing 200. Finally, the question and answer memory 130 of FIG. 1 is included in a cartridge 230. The cartridge 230 includes a connector 232 which mates with a corresponding connector (not shown in FIG. 2) inside the housing 200. The connector may be a proprietary design or may be a standard connector. Such connectors are well known in the art and will not be discussed in further detail herein. Moreover, in some embodiments of the invention, the cartridge 230 case and the corresponding opening on the housing 200 have a non-uniform shape with complimentary projections and recesses.

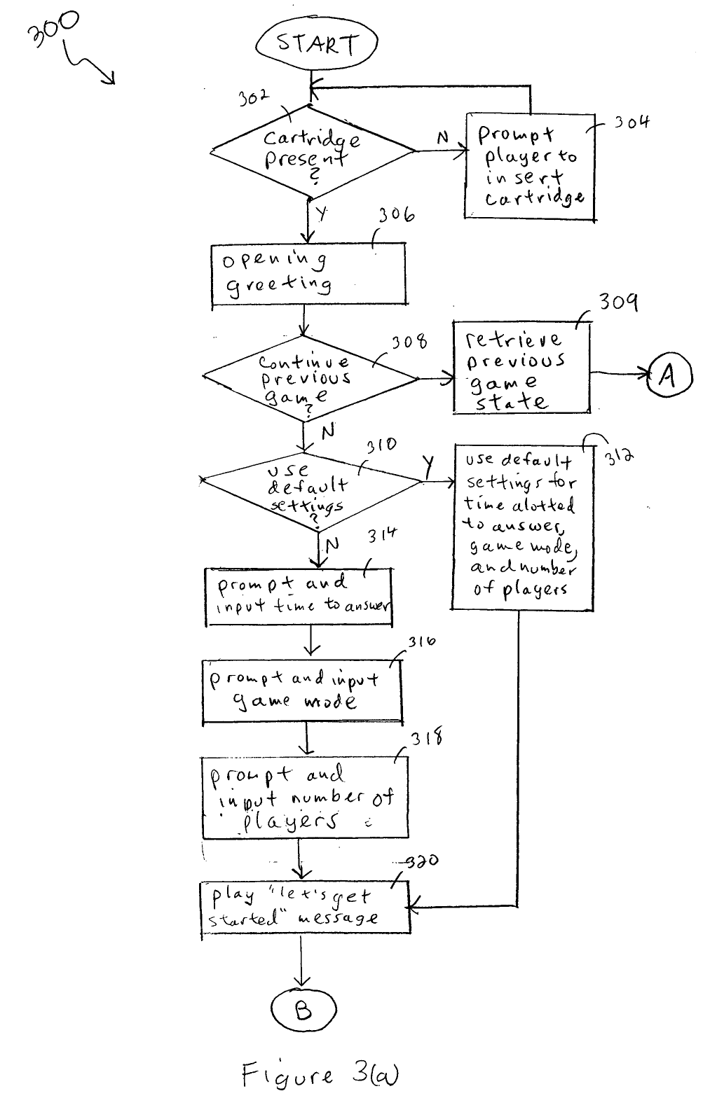

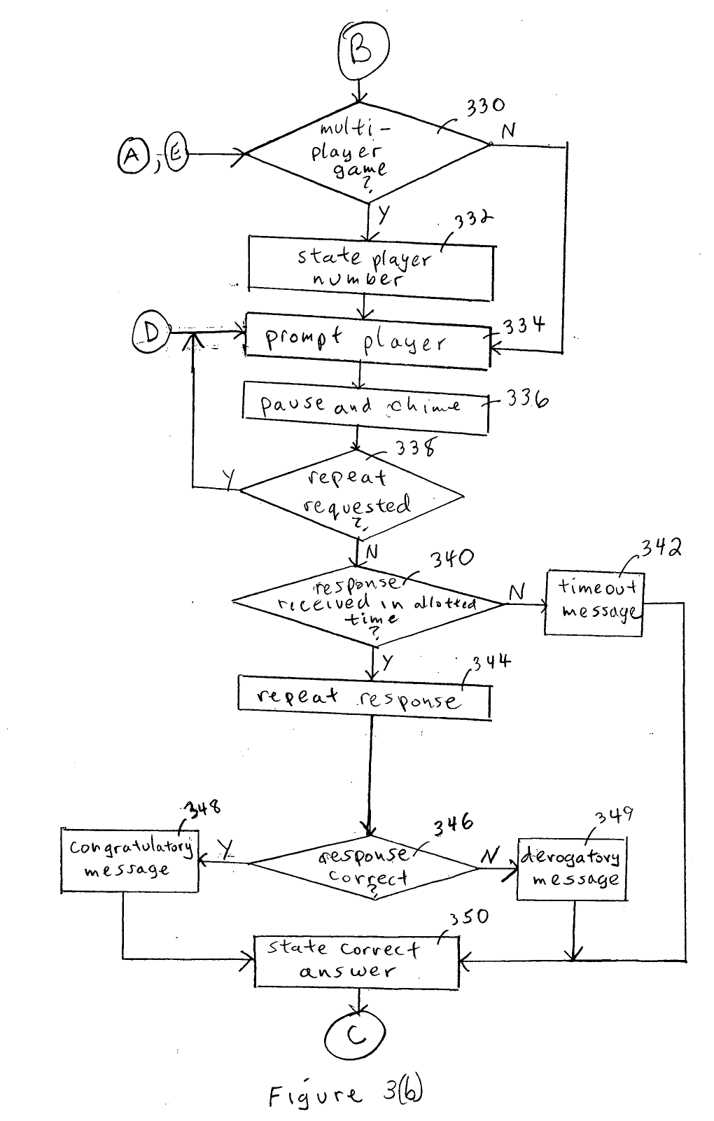

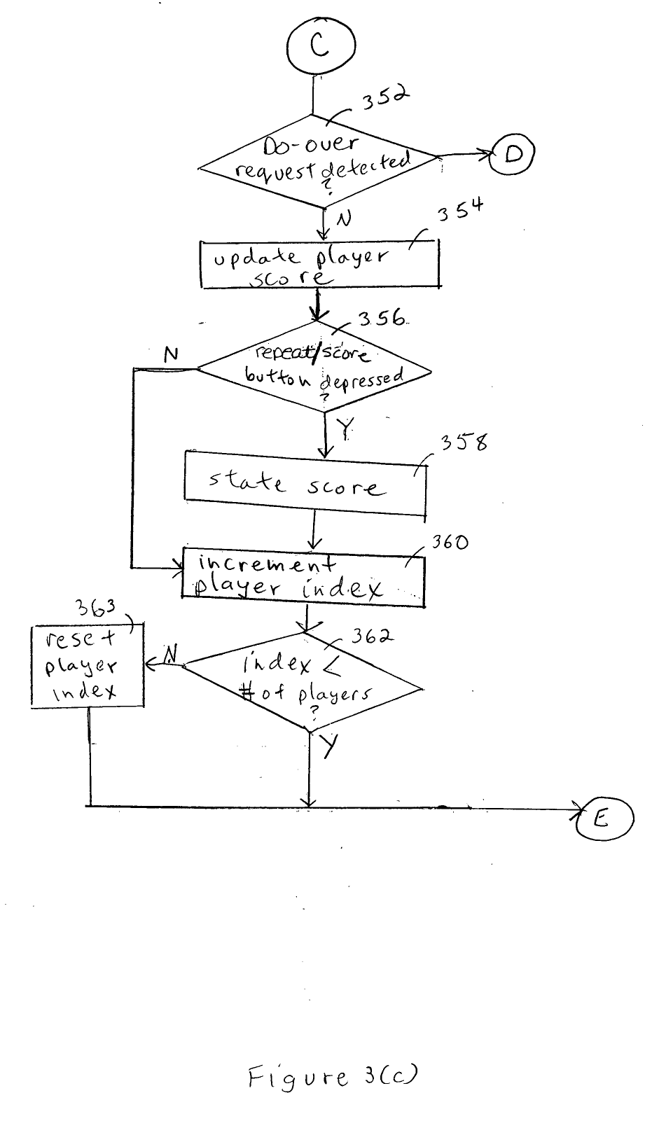

A flowchart 300 illustrating the processing performed by the processor 110 according to a preferred embodiment of the invention is illustrated in FIGS. 3a, 3b and 3c. As discussed above, the processor remains in a low power ready state until it detects a depression of the volume increase button for a threshold period of time (or a minimum number of depressions in a time period). At that point, the processor 110 determines whether a cartridge 230 is present at step 302. If no cartridge 230 is present, the processor prompts the user to insert a cartridge 230 (preferably by playing a recorded spoken instruction on the speaker 150) at step 304 and step 302 is repeated after a short delay (not shown in FIG. 3).

If the processor 110 detects a cartridge at step 302, an opening greeting is spoken to the user at step 306. The greeting may be a generic greeting (e.g., “Welcome to TALKING TRIVIA™”) stored in the program memory 120, or may be a recorded spoken statement and may be specific to the cartridge 230 (e.g., “Welcome to Sports Trivia”) and stored thereon. After the greeting at step 306, the processor asks the user if he wishes to continue a previous game at step 308. In some embodiments, the user is directed to press a “1” or “2” using the switch array 170 to indicate the desired choice. In other embodiments, the user is given the option of using the switch array 170 or speaking a response to indicate his choice. Preferably, the processor 110 acknowledges the push of a button (in this step and in other, following steps) with a tone or a voice message. If the user indicates a desire to continue a previous game at step 308, the state of the previous game is retrieved at step 309. The state of the previous game includes the number of players, the player whose turn it is, the playing mode (speaker/microphone, headset, or earphone/switch), the score, the time allotted to answer a question, and the number of questions that have been asked. In some embodiments, the score information is repeated to the user(s) during this step. Play then resumes at step 330 as discussed further below.

If the user indicates that a new game is desired at step 308, the user is asked whether default setting should be used at step 310. If the user indicates that default settings are to be used at step 310, the default settings (which are the settings used for the last game in preferred embodiments) for time allotted to answer a question, game mode, and number of players are retrieved at step 312 and the processor 110 jumps to step 320 discussed further below.

If the user does not want the default settings at step 310, the processor prompts the user to input a time in which questions must be answered and inputs the user's response at step 314. The processor 110 next prompts the user for, and inputs, the desired game mode at step 318. As discussed above, there are three game modes: (1) speaker/microphone, (2) headset, and (3) earphone/switch. The number of players in the game is obtained from the user at step 318. Next, the processor plays a recorded or simulated “let's get started” message to the user via the appropriate output device (speaker 150 or jack 151) at step 320.

Referring now to FIG. 3b, the processor determines whether the game is a multi-player game at step 330. If not, the processor 110 jumps to step 334 described further below. If the game is a multi-player game, the processor 110 states the number of the player to whom the next prompt is directed at step 322. The processor 110 then outputs the prompt to the player at step 334.

In preferred embodiments the questions are multiple choice or true/false, and the prompt includes instructions to the player to indicate his or her answer with a numeric abbreviation. This is done for two reasons. First, in speaker/microphone and headset modes, in which the user speaks a response, it minimizes the size of the vocabulary which the voice recognition software is required to recognize. Second, it allows for game play in switch mode without requiring the provision and use of an alphanumeric keypad. However, the invention should not be understood to be limited to use with numerically indicated answers.

After the prompt is output at step 334, the processor 110 pauses for a time corresponding to the time allotted for an answer as established during the set-up phase (i.e., steps 308-318) and sounds a chime (or a tone or voice message) at the end of this time period at step 336. If a repeat has been requested at step 338, either by pressing the combination “say again”/score button 160 or by speaking “say again,” step 334 is repeated. Next, the processor determines whether a response was received in the allotted time at step 340. If no response was received (meaning that no depression of a numeric switch in array 170 was sensed or that the voice recognition software detected no numeric spoken response) during the allotted time at step 340, a timeout message (which may be a spoken message or a beep) is sounded at step 342 and the processor continues at step 350 as described further below.

If a response was received at step 340, the processor 110 repeats the response that it detected at step 344 and then determines whether the response is correct at step 346 by comparing the response with the corresponding correct answer stored in the memory 130 disposed in the cartridge 230. Depending on whether the response is correct, either a congratulatory message (e.g., a chime or a spoken congratulatory message) at step 348 or a derogatory message (e.g., a buzzer or a spoken derogatory message) at step 349 is played to the user. The processor 110 then states the correct answer at step 350.

Referring now to FIG. 3(c), the processor 110 then pauses to give the user an opportunity to request a do-over and determines whether a do-over has been requested at step 352. A do-over allows the user to correct a situation in which the voice recognition software has misunderstood the user's response. In preferred embodiments, a do-over can only be requested by speaking the words “do-over.” The rationale for including no provisions for requesting a do-over with a switch is that an error in entering an answer in an earphone/switch mode game is the fault of the user rather than the voice recognition software and therefore should not be excused. If a do-over has been requested, the processor 110 jumps to step 334.

If no do-over request is detected at step 352, the user's score is updated at step 354. Next, the processor 110 determines whether the combination “say again”/score button 160 (which acts as both a repeat button and a score button depending on when pressed as discussed above) is depressed at step 356. If so, the processor 110 states the user's score at step 358, preferably using a speech synthesis routine.

Next, or if the “say again” button 160 was not depressed at step 356, the processor increments the player index at step 360. The player index is used by the processor 110 to indicate which player is to answer the next question and as an index into a memory array of scores corresponding to each player. The incremented player index is then compared to the number of players at step 362. In preferred embodiments, the player index ranges from 0-3, which corresponds to 1-4 players. Thus, when the player equals the number of players (e.g., the player index has been incremented to four in a four player game), it has been incremented too far. If the player index is less than the number of players at step 362, the processor 110 jumps to step 330. Otherwise, the player index is reset at step 363.

The processor 110 then jumps to step 330 to repeat the process. This loop will continue for as long as the players desire to continue play.

Certain operational details have been omitted from the flowchart 300. For example, if no user input is detected during any two minute period, the processor 110 will interpret this as an indication that the game play has ended and will notify the user that it is shutting down with a voice message or tone, store the state of the current game, and enter the low power ready state. Similarly, if the volume decrease button is depressed for a threshold period of time, the processor 110 will similarly save the game state and enter the low power ready state.

The questions may be selected from the memory 130 and presented to the user randomly (as used herein, “random” and “randomly” should be understood to include “pseudo-random” and “pseudo-randomly”) or in order. Selecting the questions randomly is appropriate for a trivia game and an examination. However, in embodiments of the invention used for general educational purposes, the questions may be presented in order. One reasons for presenting the questions in order is that the subject matter of subsequent questions and answers may build on the subject matter of previous questions and answers.

In some embodiments, the question and answer memory 130 may comprise a changeable, non-volatile form of memory such as flash or EEPROM. In some of these embodiments, provisions are made to allow the downloading of new questions and answers to the memory 130. For example, the new questions and answers may be delivered via the internet and communicated to the system using a wireless communications technology such as 802.11b or Bluetooth.

In some embodiments of the invention, the user may hot-swap cartridges 230 with different subject matter. Thus, a user may start a game with a sports trivia cartridge and then change to a movie trivia cartridge and continue the game with the same score without powering the device down.

Although the invention has been discussed above in the context of a hand-held trivia game, it will be apparent to those of skill in the art that the game could be played on devices other than hand-held devices. Such devices include general purpose devices such as a computer as well as special purpose devices. Additionally, although the embodiment described above is a trivia game, it will be readily apparent to those of skill in the art that the device can be readily modified for other purposes, such as for practice and actual examinations and surveys. All of the foregoing should be understood to be within the scope of the invention. Obviously, numerous other modifications and variations of the present invention are possible in light of the above teachings. It is therefore to be understood that within the scope of the appended claims, the invention may be practiced otherwise than as specifically described herein.

What is claimed is:

1. A computerized method for conducting a query comprising the steps of:
(a) generating a spoken prompt under the control of a computer;
(b) accepting under the control of a computer a spoken response from a human being;
(c) producing a logical representation of the spoken response using a voice recognition process performed by a computer;
(d) determining on a computer whether the logical representation corresponds to a correct response; and
(e) generating an audible indication as to whether the logical representation corresponds to the correct response.

2. The method of claim 1, wherein the step of generating a spoken prompt includes the step of reproducing a recorded human speech segment.

3. The method of claim 1, wherein the spoken prompt is synthesized by a computer.

4. The method of claim 1, wherein the audible indication is indicative of a correctness of a single spoken response.

5. The method of claim 1, wherein the audible indication is spoken.

6. The method of claim 5, wherein the audible indication is indicative of a correctness of a plurality of spoken responses.

7. The method of claim 5, wherein the audible indication is in the form of a score.

8. The method of claim 1, wherein steps (a) through (e) are repeated for a plurality of human beings during a single session.

9. The method of claim 1, wherein the spoken prompts are in the form of trivia questions.

10. The method of claim 1, wherein the spoken prompts are in the form of examination questions.

11. The method of claim 1, wherein the spoken prompt includes a plurality of possible responses along with a corresponding abbreviation for each possible response.

12. The method of claim 11, wherein the corresponding abbreviations are numerical abbreviations.

13. The method of claim 11, wherein the spoken response is one of the abbreviations.

14. A device for conducting a query a human being's knowledge comprising:
a speaker;
a microphone;
a computer connected to the speaker and to the microphone, the computer being configured to perform the steps of
(a) generating via the speaker a spoken prompt;
(b) accepting via the microphone a spoken response from a human being;
(c) producing a logical representation of the spoken response using a voice recognition process;
(d) determining whether the logical representation corresponds to a correct response; and
(e) generating an audible indication as to whether the logical representation corresponds to the correct response.

15. The device of claim 14, further comprising a memory connected to the processor, the memory having stored therein data corresponding to a plurality of spoken prompts and a plurality of corresponding correct responses.

16. The device of claim 15, wherein the memory is a changeable, non-volatile memory and wherein the computer is further configured to replace the data with new data corresponding to a plurality of new spoken prompts and a plurality of new corresponding correct answers.

17. The device of claim 15, wherein the spoken prompts are selected from the memory in random order.

18. The device of claim 15, further comprising a housing sized to be held in a human hand, wherein the processor, the speaker, and the microphone are all disposed within the housing.

19. The device of claim 18, wherein the memory is disposed within the housing.

20. The device of claim 18, wherein the housing further the comprises a first connector and wherein memory is disposed within a cartridge having a second connector configured to mate with the first connector.

21. The device of claim 14, wherein the step of generating a spoken prompt is performed by reproducing a recorded human speech segment.

22. The device of claim 14, wherein the spoken prompt is synthesized by the computer.

23. The device of claim 14, wherein the audible indication is indicative of a correctness of a single spoken response.

24. The device of claim 14, wherein the audible indication is spoken.

25. The device of claim 12, wherein the audible indication is indicative of a correctness of a plurality of spoken responses.

26. The device of claim 12, wherein the audible indication is in the form of a score.

27. The device of claim 14, wherein steps (a) through (e) are repeated for a plurality of human beings during a single session.

28. The device of claim 14, wherein the spoken prompts are in the form of trivia questions.

29. The device of claim 14, wherein the spoken prompts are in the form of examination questions.

30. The device of claim 14, wherein the spoken prompts are in the form of general education questions.

31. The device of claim 14, wherein the spoken prompt includes a plurality of possible responses along with a corresponding abbreviation for each possible response.

32. The device of claim 31, wherein the corresponding abbreviations are numerical abbreviations.

33. The device of claim 31, wherein the spoken response is one of the abbreviations.
